(19) United States
(12) Patent Application Publication
(10) Pub. No.: US 2015/0269164 A1
(43) Pub. Date: Sep. 24, 2015

(54) ELECTRONIC DEVICE AND CONTACT DISPLAY METHOD THEREFOR

(71) Applicant: Samsung Electronics Co., Ltd., Suwon-si (KR)

(72) Inventors: Hangcheon JO, Incheon (KR); Seungeun LEE, Seoul (KR); Seongmin JE, Bucheon-si (KR)

(21) Appl. No.: 14/665,289

(22) Filed: Mar. 23, 2015

(30) Foreign Application Priority Data
Mar. 24, 2014 (KR) 10-2014-0033857

(51) Int. Cl. G06F 17/30; G06F 3/0484

(52) U.S. Cl. CPC G06F 17/3053; G06F 3/0484

(57) ABSTRACT

A method for displaying contacts in an electronic device is provided. The method includes receiving user information corresponding to a contact from an external device, computing an intimacy level of the corresponding contact, and displaying the contact together with the user information on the basis of the intimacy level.

### CROSS-REFERENCE TO RELATED APPLICATION(S)

This application claims the benefit under 35 U.S.C. §119(a) of a Korean patent application filed on Mar. 24, 2014 in the Korean Intellectual Property Office and assigned Serial number 10-2014-0033857, the entire disclosure of which is hereby incorporated by reference.

### TECHNICAL FIELD

The present disclosure relates to a method of displaying contacts using a reorganized contacts list and an electronic device supporting the method.

### BACKGROUND

With the popularization of mobile terminals, many people maintain human relations using data stored in their mobile terminals. Recently, advances in the Internet technology enable users of mobile terminals to readily access various types of information and to converse with each other in real time through social networking services such as Microsoft Network (MSN), KakaoTalk, NateON, BuddyBuddy, Facebook, and Twitter. Service subscribers may manage and utilize address books through social networking services. However, mobile messengers such as KakaoTalk use proprietary protocols to provide specific services to their subscribers. It is difficult to exchange messages and files between heterogeneous social networks other than the same social network. To overcome such service limitations, mobile communication companies (e.g., network operators) have developed Rich Communication Suite (RCS) services that enable mobile terminals to exchange messages and files without subscription to particular messenger applications. RCS may be regarded as a next generation integrated communication service that permits subscribers of different social networks to use various functions related to voice calls, short message services (SMS), chatting, file transfer, and data sharing. In particular, deployment of the Long Term Evolution (LTE) technology and introduction of Voice over LTE (VoLTE) may significantly increase utilization of RCS services. Three main features of RCS may be summarized as follows. First, the “rich call” feature enables users to share moving images or photographs and to chat during a call. Second, the “rich address book” feature enables a user of a mobile phone to view the status of the counterpart in real time. Third, the “rich messaging” feature, although similar to that of an existing mobile messenger, enables a user to select a person or a group of persons from the address book and directly start chatting with the selected person or group or send a file thereto. Unlike existing social networking services, the RCS features can be “standardized” and can be “installed in terminals by default”. The standardized RCS service may distribute information of communication subscribers through a mobile communication server. RCS may provide various services to subscribers (e.g., users of mobile terminals) utilizing information of communication subscribers.

The above information is presented as background information only to assist with an understanding of the present disclosure. No determination has been made, and no assertion is made, as to whether any of the above might be applicable as prior art with regard to the present disclosure.

### SUMMARY

In a related art scheme for displaying contacts in an electronic device, addresses, names and group identities forming individual contacts are listed simply in alphabetical order or in order of registration. In this case, when a large number of contacts are recorded in the address book, it takes a long time and effort for the user to find a specific contact in the address book. In addition, the user may fail to recall particular information on a person (e.g., anniversary) corresponding to a contact unless such information is stored separately or an alarm is set therefor. In other words, to timely celebrate an anniversary of a person corresponding to a contact, the user may have to remember the anniversary and set a notification or alarm for the corresponding date.

Aspects of the present disclosure are to address at least the above-mentioned problems and/or disadvantages and to provide at least the advantages described below. Accordingly, an aspect of the present disclosure is to provide an electronic device that can receive at least one piece of user information corresponding to a given contact from an external device and display the received user information on a display unit in a manner intuitively obvious to the user.

In accordance with an aspect of the present disclosure, a method for displaying contacts in an electronic device is provided. The method includes receiving user information corresponding to a contact from an external device, computing an intimacy level of the corresponding contact, and displaying the contact together with the user information based on the intimacy level.

In accordance with another aspect of the present disclosure, a method for sending user information from an external device to an electronic device is provided. The method includes receiving user information from a first electronic device related with a contact of a contacts list, and sending the user information to a second electronic device listed in the contacts list in a timely manner according to a scheduled date indicated by the received user information.

In accordance with another aspect of the present disclosure, an electronic device is provided. The electronic device includes a wireless communication unit configured to receive user information related with a contact from an external device, a display, and a processor configured to perform a process of receiving user information corresponding to a contact from the external device, computing an intimacy level of the corresponding contact, and displaying the contact together with the user information based on the intimacy level.

In a feature of the present disclosure, the method enables the electronic device to receive user information related to a contact (e.g., birthday or anniversary) through Rich Communication Suite (RCS) without setting an alarm for the user information or storing the user information in advance. When the contacts list (or address book) is viewed by the user, the user information may be displayed on the display unit in an intuitive manner. That is, the electronic device may receive user information (e.g., birthday or anniversary) from an external device (e.g., server) and display the user information on the contacts list (e.g., address book) in a convenient manner. For example, the electronic device may display the contact related to the received user information as the topmost entry of the contacts list or as a fixed image on the contacts list, enabling the user to intuitively identify the user information. In addition, the electronic device may directly provide functions such as “send message”, “make call”, “offer gift” and the like, so that the user can conveniently send congratulations while browsing the contacts list.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including electronic devices according to an embodiment of the present disclosure;

FIG. 2 is a block diagram of an electronic device according to an embodiment of the present disclosure;

FIG. 3 is a sequence diagram illustrating a scheme for receiving user information from a server according to an embodiment of the present disclosure;

FIG. 4 is a flowchart of a method for displaying user information related to a contact along with reorganization of a contacts list according to an embodiment of the present disclosure;

FIG. 5 is a screen representation for displaying status windows and status indications on a contacts list according to an embodiment of the present disclosure;

FIG. 6 is a screen representation for moving a contact whose intimacy level is above a threshold value to the topmost position on a contacts list according to an embodiment of the present disclosure;

FIG. 7 is a screen representation for outputting a contact whose intimacy level is above a threshold value as an image fixed on a contacts list according to an embodiment of the present disclosure;

FIG. 8 is a screen representation for determining display order of multiple contacts whose intimacy levels are above a threshold value according to an embodiment of the present disclosure;

FIG. 9 is a screen representation in which, when multiple contacts have an intimacy level higher than a threshold value, distances to electronic devices related respectively with the multiple contacts are estimated and displayed on a contacts list, and the display order of the multiple contacts is determined in accordance with the estimated distances according to an embodiment of the present disclosure;

FIG. 10 is a flowchart of a method for displaying an options window in a reorganized contacts list and performing a function selected through the options window according to an embodiment of the present disclosure; and

FIG. 11 is a screen representation for displaying an options window including available functions in response to user selection on a status information field according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that the expressions “comprises” and “may comprise” are used to specify presence of disclosed function, operation, component, etc. but do not preclude the presence of one or more functions, operations, components, etc. It will be further understood that the terms “comprises” and/or “has” when used in this specification, specify the presence of stated feature, number, operation, component, element, or a combination thereof but do not preclude the presence or addition of one or more other features, numbers, operations, components, elements, or combinations thereof. In the present disclosure, the expression “and/or” is taken as specific disclosure of each and any combination of enumerated things. For example, A and/or B is to be taken as specific disclosure of each of A, B, and A and B.

As used herein, terms such as “first,” “second,” etc. are used to describe various components; however, the components should not be defined by these terms. For example, the terms do not restrict the order and/or importance of the corresponding components. The terms are used only for distinguishing one component from another component. For example, a first component may be referred to as a second component and likewise, a second component may also be referred to as a first component, without departing from the teaching of the inventive concept.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

Unless otherwise defined herein, all terms including technical or scientific terms used herein have the same meanings as commonly understood by those skilled in the art to which the present disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

According to various embodiments of the present disclosure, the electronic device may include devices having an operation support function. Examples of the electronic device may include smartphone, table Personal Computer (PC), mobile phone, video phone, electronic book (e-book) reader, desktop PC, laptop PC, netbook computer, Personal Digital Assistant (PDA), Portable Multimedia Player (PMP), MP3 player, mobile medical appliance, camera, wearable device (e.g., head-mounted device (HMD) such as electronic glasses, electronic clothing, electronic bracelet, electronic necklace, electronic accessory, electronic tattoo, smartwatch, etc.).

According to an embodiment of the present disclosure, the electronic device may be a smart home appliance having operation support function. Examples of the smart electronic appliance as an electronic device may include television, Digital Versatile Disk (DVD) player, audio player, refrigerator, air-conditioner, vacuum cleaner, electronic oven, microwave oven, laundry machine, air cleaner, set-top box, TV box (e.g., Samsung HomeSync™, Apple TV™, and Google TV™), game console, electronic dictionary, electronic key, camcorder, and electronic frame, etc.

According to an embodiment of the present disclosure, examples of the electronic device may include medical device (e.g., Magnetic Resonance Angiography (MRA), Magnetic Resonance Imaging (MRI), Computed Tomography (CT)), Navigation device, Global Positioning System (GPS) receiver, Event Data Recorder (EDR), Flight Data Recorder (FDR), car infotainment device, maritime electronic device (e.g., maritime navigation device and gyro compass), aviation electronic device (avionics), security device, vehicle head unit, industrial or home robot, Automatic Teller's Machine (ATM) of financial institution, Point Of Sales (POS), etc.

According to an embodiment of the present disclosure, examples of the electronic device may include furniture and building/structure having a communication function, electronic board, electronic signature receiving device, projector, and metering device (e.g., water, electric, gas, and electric wave metering devices). According to various embodiments of the present disclosure, the electronic device may be any combination of the aforementioned devices. According to various embodiments of the present disclosure, the electronic device may be a flexible device. However, the electronic device is not limited to the aforementioned devices.

Descriptions are made of the electronic devices according to various embodiments of the present disclosure with reference to accompanying drawings hereinafter. The term ‘user’ used in various embodiments of the present disclosure may denote a person or a device (e.g., artificial intelligent electronic device) using the electronic device.

In an embodiment of the present disclosure, the term ‘object screen’ may denote the screen including execution icons of applications installed in the electronic device, favorite webpage icons, folders, files, images, etc. In an embodiment of the present disclosure, the object screen may include at least one tab screen, e.g., ‘recent’ tab screen, ‘object’ tab screen, ‘download’ tab screen, and ‘recommend’ tab screen. The objects may be presented differently depending on the tab screen. In detail, the recent tab screen may be the screen of displaying the objects running or having execution history. The object tab screen may be the screen presenting the objects installed in the electronic device that are arranged according to the user setting. The download tab screen may be the screen presenting the objects installed in the electronic device. The ‘recommend’ tab screen presents the objects recommended based on the information on the objects executed by user.

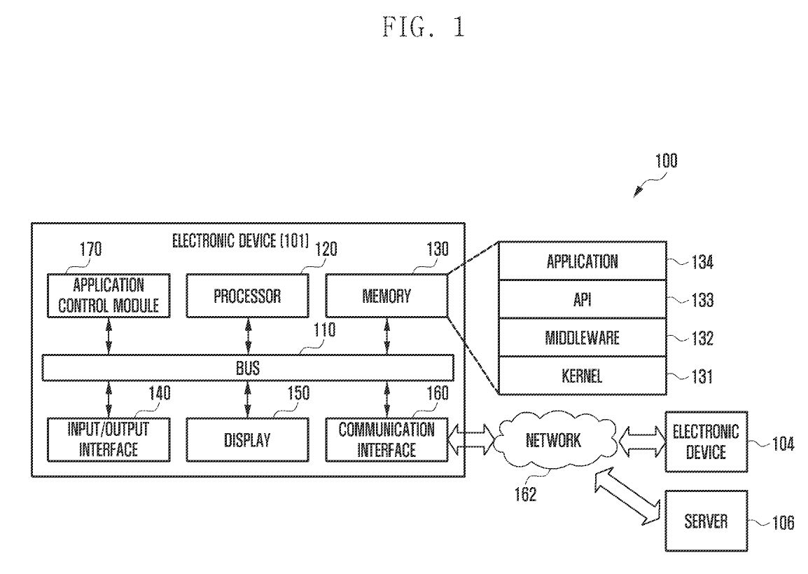

FIG. 1 is a diagram illustrating a network environment including electronic devices according to an embodiment of the present disclosure.

Referring to FIG. 1, the network environment 100 includes electronic devices 101 and 104, a server 106, and a network 162. The electronic device 101 may include a bus 110, a processor 120, a memory 130, an input/output interface 140, a display 150, a communication interface 160, and an application control module 170.

The bus 110 connects the aforementioned components to each other and may be a circuit of exchanging signals (e.g., control messages) among the components.

For example, the processor 120 receives a command from any of the aforementioned components (e.g., memory 130, input/output interface 140, display 150, communication interface 160, and operation module 170) through the bus 110, interprets the command, and executes operation or data processing according to the decrypted command.

The memory 130 may store the command or data received from the processor 120 or other components (e.g., input/output interface 140, display 150, communication interface 160, operation module 170, etc.) or generated by the processor 120 or other components. The memory 130 may store program modules including kernel 131, middleware 132, Application Programming Interface (API) 133, applications 134, and the like. Each programming module may be implemented as software, firmware, hardware, and any combination thereof.

The kernel 131 may control or manage the system resources (e.g., bus 110, processor 120, and memory 130) for use in executing the operation or function implemented with the middleware 132, the API 133, or the application 134. The kernel 131 also may provide an interface allowing the middleware 132, API 133, or application 134 to access the components of the electronic device 101 to control or manage.

The middleware 132 may work as a relay of data communicated between the API 133 or application 134 and the kernel 131. The middleware 132 may execute control of the task requests from the applications 134 in such a way of assigning priority for use of the system resource (e.g., bus 110, processor 120, and memory 130) of the electronic device to at least one of the applications 134.

The API 133 is the interface for the applications 134 to control the function provided by the kernel 131 or the middleware 132 and may include at least one interface or function (e.g., command) for file control, window control, image control, or text control.

According to various embodiments of the present disclosure, the applications 134 may include Short Message Service/Multimedia Messaging Service (SMS/MMS) application, email application, calendar application, alarm application, health care application (e.g., application of measuring quantity of motion or blood sugar level), and environmental information application (e.g., atmospheric pressure, humidity, and temperature applications). Additionally or alternatively, the application 134 may be an application related to information exchange between the electronic device 101 and other external electronic device (e.g., electronic device 104). Examples of the information exchange application may include a notification relay application for relaying specific information to the external electronic device and a device management application for managing the external electronic device.

For example, the notification relay application may be provided with a function of relaying the alarm information generated by the other applications (e.g., SMS/MMS application, email application, health care application, and environmental information application) of the electronic device 101 to an external electronic device (e.g., electronic device 104). Additionally or alternatively, the notification relay application may provide the user with the notification information received from an external electronic device (e.g., electronic device 104). The electronic device application may manage (e.g., install, delete, and update) the function of an external electronic device (e.g., turn-on/off of the electronic device 104 (or a portion of the electronic device 104) or adjustment of the brightness (or resolution) of the display) which communicates with the electronic device 101 or the service (e.g., communication or messaging service) provided by the external electronic device or an application running on the external device.

According to various embodiments of the present disclosure, the applications 134 may include an application designated according to the property (e.g., type) of an external electronic device (electronic device 104). If the external electronic device is an MP3 player, the applications 134 may include a music playback application. Similarly, if the external electronic device is a mobile medical appliance, the applications 134 may include a health care application. According to an embodiment of the present disclosure, the application 134 may include at least one of applications designated to the electronic device 101 or the applications received from the external electronic device (e.g., server 106 and electronic device 104).

The input/output interface 140 delivers the command or data input by the user through with an input/output device (e.g., sensor, keyboard, and touchscreen) to the processor 120, memory 130, communication interface 160, and/or operation module 170 through the bus 110. For example, the input/output interface 140 may provide the processor 120 with the data corresponding to the touch may by the user on the touchscreen. The input/output interface 140 may output the command or data (which is received from the processor 120, memory 130, communication interfaced 160, or the operation module 170 through the bus 110) through the input/output device (e.g., speaker and display). For example, the input/out interface 140 may output the voice data processed by the processor 120 to the user through the speaker.

The display 150 may present various information (e.g., multimedia data and text data) to the user.

The communication interface 160 may establish a communication connection of the electronic device 101 with an external device (e.g., electronic device 104 and server 106). For example, the communication interface 160 connects to the network 162 through a wireless or wired link for communication with the external device. Examples of the wireless communication technology may include Wi-Fi, Bluetooth (BT), Near Field Communication (NFC), Global Positioning System (GPS), and cellular communication technology (e.g., Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology may include Universal Serial Bus (USB), High Definition Multimedia Interface (HDMI), Recommended Standard 232 (RS-232), and Plain Old Telephone Service (POTS).

According to an embodiment of the present disclosure, the network 162 may be a telecommunication network. The communication network may include at least one of computer network, Internet, Internet of Things, and telephone network. According to an embodiment of the present disclosure, the communication protocol between the electronic device 101 and an external device (e.g., transport layer protocol, data link layer protocol, and physical layer protocol) may be supported by at least one of the applications 134, API 133, middleware 132, kernel 131, and communication interface 160.

The application control module 170 may process information obtained from other components (e.g., processor 120, memory 130, input/output interface 140, display 150 and communication interface 160) and provide the processed information to the user in various ways. For example, the application control module 170 may identify an interface element attached to the electronic device 101, store information on the interface element in the memory 130, and activate an application 134 on the basis of the stored information. In particular, the application control module 170 may receive user information related with a contact stored in the electronic device 101 from the server 106 and display the received user information on the display 150. The application control module 170 may intuitively present an anniversary or the like of a person corresponding to a contact stored in the memory 130 to the user of the electronic device 101.

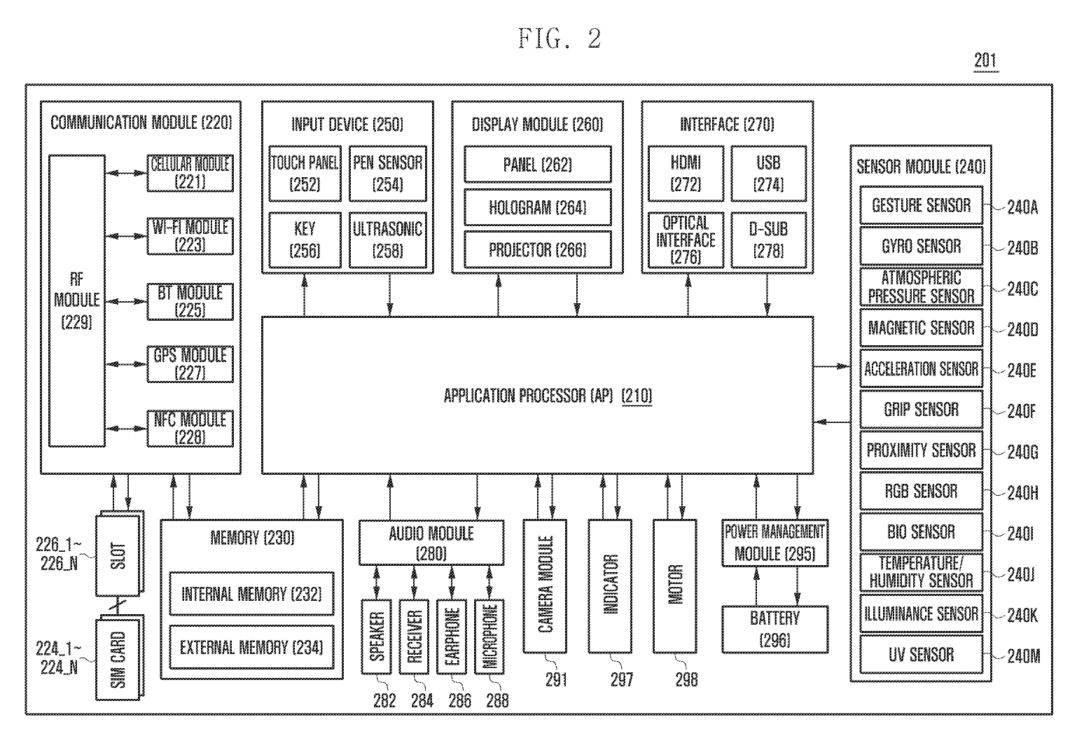

FIG. 2 is a block diagram illustrating a configuration of the electronic device according to various embodiments of the present disclosure. The electronic device 201 may be the whole or a part of the electronic device 101.

Referring to FIG. 2, the electronic device 201 may include an Application Processor (AP) 210, a communication module 220, one or more Subscriber Identity Module (SIM) cards 224_1 to 224_N, a memory 230, a sensor module 240, an input device 250, a display 260, an interface 270, an audio module 280, a camera module 291, a power management module 295, a battery 296, an indicator 297, and a motor 298.

The AP 210 may operate an Operating System (OS) and/or application programs to control a plurality of hardware and/or software components connected to the AP 210 and perform data-processing and operations on multimedia data. For example, the AP 210 may be implemented in the form of System on Chip (SoC). According to an embodiment of the present disclosure, the AP 210 may include a Graphic Processing Unit (GPU) (not shown).

The communication module 220 (e.g., communication interface 160) may perform data communication with other electronic devices (e.g., electronic device 104 and server 106) through a network. According to an embodiment of the present disclosure, the communication module 220 may include a cellular module 221, a Wi-Fi module 223, a BT module 225, a GPS module 227, an NFC module 228, and a Radio Frequency (RF) module 229.

The cellular module 221 is responsible for voice and video communication, text messaging, and Internet access services through a communication network (e.g., LTE, LTE-A, CDMA, WCDMA, UMTS, WiBro, and GSM networks). The cellular module 221 may perform identification and authentication of electronic devices in the communication network using the SIM card 224. According to an embodiment of the present disclosure, the cellular module 221 may perform at least one of the functions of the AP 210. For example, the cellular module 221 may perform at least a part of the multimedia control function.

According to an embodiment of the present disclosure, the cellular module 221 may include a Communication Processor (CP). The cellular module 221 may be implemented in the form of SoC. Although the cellular module 221 (e.g., communication processor), the memory 230, and the power management module 295 are depicted as independent components separated from the AP 210, the present disclosure is not limited thereto and may be embodied in a way that the AP includes at least one of the components (e.g., cellular module 221).

According to an embodiment of the present disclosure, each of the AP 210 and the cellular module 221 (e.g., CP) may load a command or data received from at least one of the components on a non-volatile or volatile memory and process the command or data. The AP 210 or the cellular module 221 may store the data received from other components or generated by at least one of other components in the non-volatile memory.

Each of the Wi-Fi module 223, the BT module 225, the GPS module 227, and the NFC module 228 may include a processor for processing the data it transmits/receives. Although the cellular module 221, the Wi-Fi module 223, the BT module 225, the GPS module 227, and the NFC module 228 are depicted as independent blocks; at least two of them (e.g., CP corresponding to the cellular module 221 and Wi-Fi processor corresponding to the Wi-Fi module 223) may be integrated in the form of SoC.

The RF module 229 is responsible for data communication, e.g., transmitting/receiving RF signals. Although not depicted, the RF module 229 may include a transceiver, a Power Amp Module (PAM), a frequency filter, and a Low Noise Amplifier (LNA). The RF module 229 also may include the elements for transmitting/receiving electric wave in free space, e.g., conductor or conductive wire. Although FIG. 2 is directed to the case where the Wi-Fi module 223, the BT module 225, the GPS module 227, and the NFC module 228 are sharing the RF module 229, the present disclosure is not limited thereto and may be embodied in a way that at least one of the Wi-Fi module 223, the BT module 225, the GPS module 227, and the NFC module 228 transmits/receives RF signals an independent RF module.

The SIM card 224 may be designed so as to be inserted into a slot formed at a predetermined position (e.g., slot 226 of the electronic device. The SIM card 224 may store unique identity information (e.g., Integrated Circuit Card Identifier (ICCID)) or subscriber information (e.g., International Mobile Subscriber Identity (IMSI)).

The memory 230 (e.g., memory 130) may include at least one of the internal memory 232 and an external memory 234. The internal memory 232 may include at least one of a volatile memory (e.g., Dynamic Random Access Memory (DRAM), Static RAM (SRAM), Synchronous DRAM (SDRAM) or a non-volatile memory (e.g., One Time Programmable Read Only Memory (OTPROM), Programmable ROM (PROM), Erasable and Programmable ROM (EPROM), Electrically Erasable and Programmable ROM (EEPROM), mask ROM, flash ROM, Not And (NAND) flash memory, and Not Or (NOR) flash memory)

According to an embodiment of the present disclosure, the internal memory 232 may be a Solid State Drive (SSD). The external memory 234 may be a flash drive such as Compact Flash (CF), Secure Digital (SD), micro-SD, Mini-SD, extreme Digital (xD), and Memory Stick. The external memory 234 may be connected to the electronic device 201 through various interfaces functionally. According to an embodiment of the present disclosure, the electronic device 201 may include a storage device (or storage medium) such as hard drive.

The sensor module 240 may measure physical quantity or check the operation status of the electronic device 201 and convert the measured or checked information to an electric signal. The sensor module 240 may include at least one of gesture sensor 240A, Gyro sensor 240B, barometric sensor 240C, magnetic sensor 240D, acceleration sensor 240E, grip sensor 240F, proximity sensor 240G, color sensor 240H (e.g., Red, Green, Blue (RGB) sensor), bio sensor 240I, temperature/humidity sensor 240J, illuminance sensor 240K, and Ultraviolet (UV) sensor 240M. Additionally or alternatively, the sensor module 240 may include E-nose sensor (not shown), Electromyography (EMG) sensor (not shown), Electroencephalogram (EEG) sensor (not shown), Electrocardiogram (ECG) sensor (not shown), Infrared (IR) sensor (not shown), iris sensor (not shown), and fingerprint sensor (not shown). The sensor module 240 may further include a control circuit for controlling at least one of the sensors included therein.

The input device 250 may include a touch panel 252, a (digital) pen sensor 254, keys 256, and an ultrasonic input device 258. The touch panel 252 may be one of capacitive, resistive, infrared, microwave type touch panel. The touch panel 252 may include a control circuit. In the case of the capacitive type touch panel, it is possible to detect physical contact or approximation. The touch panel 252 may further include a tactile layer. In this case, the touch panel 252 may provide the user with haptic reaction.

The (digital) pen sensor 254 may be implemented with a sheet with the same or similar way as touch input of the user or a separate recognition sheet. The keys 256 may include physical buttons, optical key, and keypad. The ultrasonic input device 258 is a device capable of checking data by detecting sound wave through a microphone 288 and may be implemented for wireless recognition. According to an embodiment of the present disclosure, the electronic device 201 may receive the user input made by means of an external device (e.g., computer or server) connected through the communication module 220.

The display 260 (e.g., display module 150) may include a panel 262, a hologram device 264, and a projector 266. The panel 262 may be a Liquid Crystal Display (LCD) panel or an Active Matrix Organic Light Emitting Diodes (AMOLED) panel. The panel 262 may be implemented so as to be flexible, transparent, and/or wearable. The panel 262 may be implemented as a module integrated with the touch panel 252. The hologram device 264 may present 3-dimensional image in the air using interference of light. The projector 266 may project an image to a screen. The screen may be placed inside or outside the electronic device. According to an embodiment of the present disclosure, the display 260 may include a control circuit for controlling the panel 262, the hologram device 264, and the projector 266.

The interface 270 may include an HDMI 272, a USB 274, an optical interface 276, and a D-subminiature (D-sub) 278. The interface 270 may include the communication interface 160 as shown in FIG. 1. Additionally or alternatively, the interface 270 may include a Mobile High-definition Link (MHL) interface, an SD/MMC card interface, and infrared Data Association (irDA) standard interface.

The audio module 280 may convert sound to electric signal and vice versa. At least a part of the audio module 280 may be included in the input/output interface 140 as shown in FIG. 1. The audio module 280 may process the audio information input or output through the speaker 282, the receiver 284, the earphone 286, and the microphone 288.

The camera module 291 is a device capable of taking still and motion pictures and, according to an embodiment of the present disclosure, includes at least one image sensor (e.g., front and rear sensors), a lens (not shown), an Image Signal Processor (ISP) (not shown), and a flash (e.g., LED or xenon lamp) (not shown).

The power management module 295 may manage the power of the electronic device 201. Although not shown, the power management module 295 may include a Power Management Integrated Circuit (PMIC), a charger IC, a battery, and a battery or fuel gauge.

The PMIC may be integrated into an integrated circuit or SoC semiconductor. The charging may be classified into wireless charging and wired charge. The charger IC may charge the battery and protect the charger against overvoltage or overcurrent. According to an embodiment of the present disclosure, the charger IC may include at least one of wired charger and wireless charger ICs. Examples of the wireless charging technology includes resonance wireless charging and electromagnetic wave wireless charging, and an extra circuit for wireless charging, such as coil loop, resonance circuit, and diode, may be needed.

The battery gauge may measure the residual power of the battery 296, charging voltage, current, and temperature. The battery 296 may store or generate power and supply the stored or generated power to the electronic device 201. The battery 296 may include a rechargeable battery or a solar battery.

The indicator 297 may display operation status of the electronic device 201 or a part of the electronic device, booting status, messaging status, and charging status. The motor 298 may converts the electronic signal to mechanical vibration. Although not shown, the electronic device 201 may include a processing unit (e.g., GPU) for supporting mobile TV. The processing unit for supporting the mobile TV may be able to processing the media data abiding by the broadcast standards such Digital Multimedia Broadcasting (DMB), Digital Video Broadcasting (DVB), and media flow.

As described above, the electronic device operating method and apparatus of the present disclosure is capable of providing diverse screen displays in adaptation to various conditions to implement optimal environment for utilizing the electronic device, resulting in improvement of user convenience. Also, the electronic device operating method and apparatus of the present disclosure is advantageous in terms of facilitating navigation between folders by sorting the folders by hierarchical level.

The above enumerated components of the electronic device of the present disclosure may be implemented into one or more parts, and the names of the corresponding components may be changed depending on the kind of the electronic device. The electronic device of the present disclosure may include at least one of the aforementioned components with omission or addition of some components. The components of the electronic device of the present disclosure may be combined selectively into an entity to perform the functions of the components equally as before the combination.

The term “module” according to various embodiments of the present disclosure, means, but is not limited to, a unit of one of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be the smallest unit of performing at least one function or a part thereof. A module may be implemented mechanically or electronically. For example, a module may include at least one of Application-Specific IC (ASIC) chip, Field-Programmable Gate Arrays (FPGAs), and Programmable-Logic Device known or to be developed for certain operations.

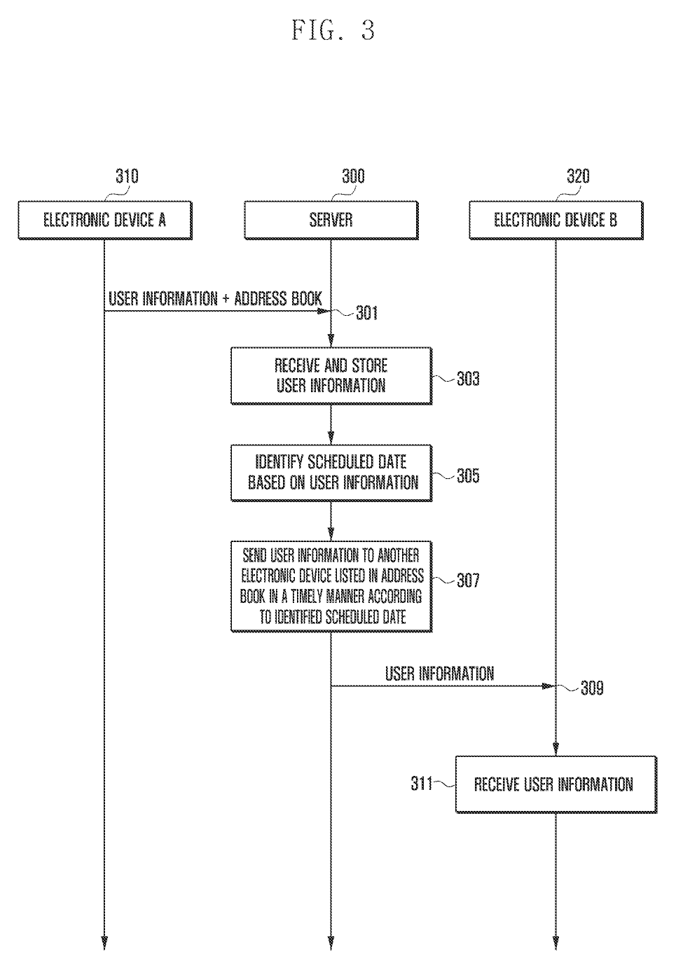

FIG. 3 is a sequence diagram illustrating a scheme for receiving user information from a server according to various embodiments of the present disclosure.

Referring to FIG. 3, at operation 301, the server 300 (e.g., external device) receives user information (e.g., scheduled event such as wedding anniversary or birthday, address book such as phonebook or email, network information, network connectivity information, status information, or location information) from an electronic device A 310. The server 300 may be a server of a mobile communication company and may identify information of communication subscribers by use of Rich Communication Suite (RCS). The server 300 may identify status information of a communication subscriber in real time through the “rich address book” feature among RCS features. The server 300 may receive user information stored in an electronic device of a communication subscriber (e.g., electronic device A 310), and may determine whether the electronic device is in a communication enabled state. At operation 303, the server 300 stores the user information received from the electronic device A 310. The server 300 may manage pieces of user information received from individual electronic devices in an integrated manner. For example, the server 300 may create a mapping table to collectively manage user information. At operation 305, the server 300 identifies a scheduled date of the electronic device A 310 on the basis of the received user information. For example, the server 300 may identify the date of a scheduled event. The server 300 may check scheduled dates in real time or at regular intervals (e.g., 1 hour, 3 hours, 6 hours or the like).

At operation 307, the server 300 sends the user information of the electronic device A 310 to other electronic devices (e.g., electronic device B 320) listed in the address book of the electronic device A 310 in a timely manner according to the identified scheduled date. Although not shown, when a different electronic device listed in the address book of the electronic device A 310 is out of the communication coverage area or in a communication disabled state, the server 300 may postpone transfer of the user information of the electronic device A 310. Sometime later, when the different electronic device enters the communication coverage area or is in a communication enabled state, the server 300 may send the user information of the electronic device A 310 to the different electronic device. At operation 309, the server 300 sends the user information of the electronic device A 310 to the electronic device B 320. At operation 311, the electronic device B 320 receives the user information of the electronic device A 310 from the server 300.

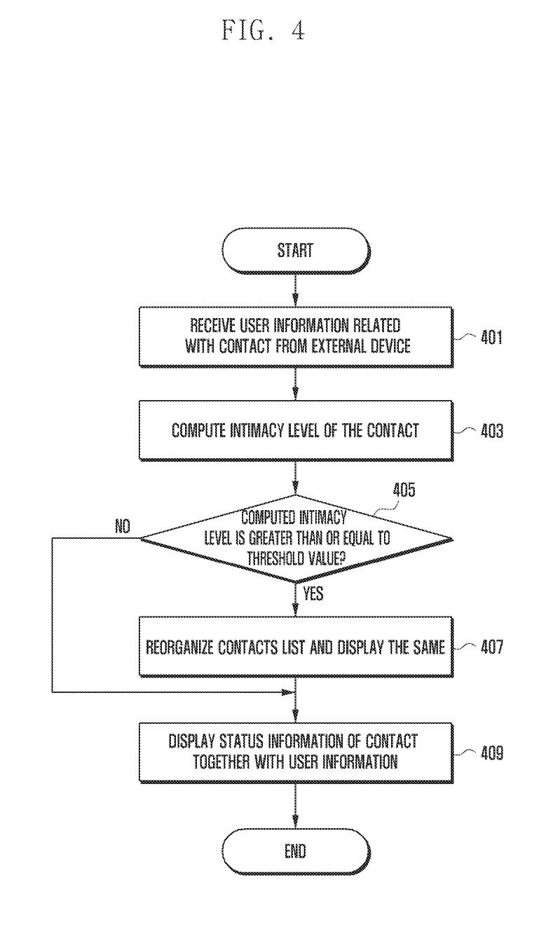

FIG. 4 is a flowchart of a method for displaying user information related to a contact along with reorganization of the contacts list according to an embodiment of the present disclosure.

Referring to FIG. 4, at operation 401, the processor 120 of the electronic device 101 receives user information related with a contact from an external device (e.g., server 300). At operation 403, the processor 120 determines the intimacy level of the contact. For example, the processor 120 may determine the intimacy level of a contact according to the frequency of usage of the contact. The level of intimacy or closeness may be a value computed on the basis of one or more of the number of calls, the number of messages, the number of missed calls, the number of silent calls, the size of a message, call duration time, the number of instant messages (e.g., KakaoTalk), the number of interactions through a Social Networking Site (SNS) (e.g., Facebook), and the relationship with the user.

After computing the intimacy level of the contact on the basis of the frequency of usage, at operation 405, the processor 120 determines whether the computed intimacy level of the contact is greater than or equal to a threshold value. The threshold value may be a reference value for the intimacy level set by the external device (e.g., server) or the user. If the computed intimacy level of the contact is greater than or equal to the threshold value, at operation 407, the processor 120 reorganizes the contacts list (e.g., address book) on the basis of the contact whose intimacy level is greater than or equal to the threshold value and displays the reorganized contacts list. Although not shown, the processor 120 may display the reorganized contacts list in response to user input for contacts list browsing. For example, to enable the user to readily recognize the user information, the processor 120 may place the contact that is related with the user information and having an intimacy level greater than or equal to the threshold value at the topmost position of the contacts list or present the above contact as an image fixed on the contacts list.

In the event that two or more contacts have scheduled events on the same date, the processor 120 may change the sequence of arrangement of the contacts according to user settings. User settings may indicate arrangement based on the intimacy level of a contact or on the distance to the electronic device corresponding to the contact. The processor 120 may compute the intimacy level of a contact on the basis of one or more of the number of calls, the number of messages, the number of missed calls, the number of silent calls, the sizes of messages, call duration times, the number of instant messages, and the number of interactions through an SNS. The processor 120 may arrange the contacts list in ascending or descending order of intimacy. Alternatively, the processor 120 may arrange the contacts list in ascending or descending order of distance between the electronic device 101 and the electronic device corresponding to a contact. The distance between the electronic device 101 and the electronic device corresponding to a contact may be measured using signals from GPS satellites. The processor 120 may output the measured distance together with the user information on the contacts list.

After displaying the reorganized contacts list, at operation 409, the processor 120 displays status information of the contact together with the user information on the contacts list. Status information of the contact may be a specific image indicating the communication connectivity of the electronic device corresponding to the contact. In other words, the processor 120 may reorganize the contacts list and display user information, which is related with a contact and is received from an external device (e.g., server), on the contacts list. The processor 120 may store information on the display of the existing contacts list (e.g., status information) in the memory 130. If the computed intimacy level of the contact is not greater than or equal to the threshold value at operation 405, the processor 120 may skip reorganization of the contacts list. The processor 120 may display the status information of the contact together with the user information without reorganization of the contacts list. Consequently, the processor 120 may display user information related with a contact on the contacts list.

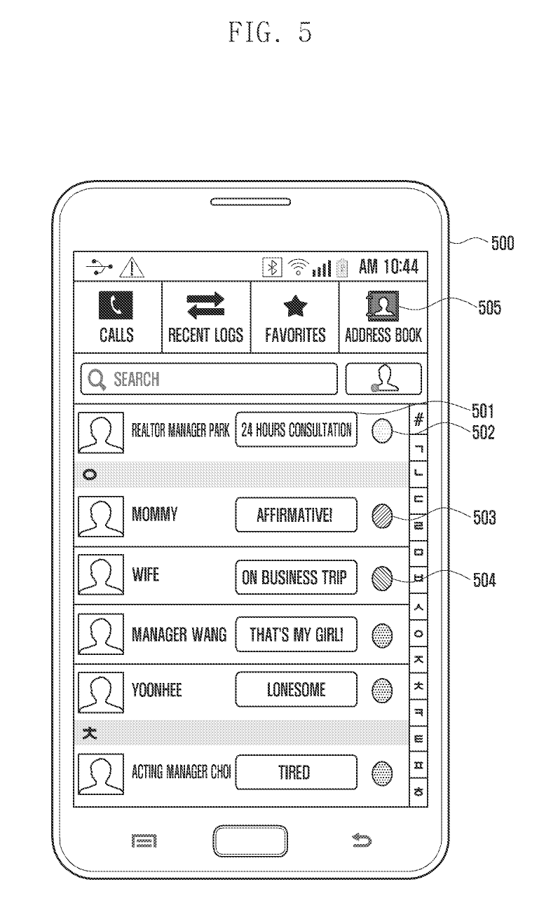

FIG. 5 is a screen representation for displaying status windows and status indications on the contacts list according to various embodiments of the present disclosure.

Referring to FIG. 5, the electronic device 500 may output an address book tab 505 containing contacts each having a status information field 501 and a state indication field 502. The address book may include a contacts list. The status information field 501 may be used to display user information corresponding to the contact and communication connectivity of the electronic device corresponding thereto. For a contact, the processor (e.g., processor 120 in FIG. 1) of the electronic device 500 may output a memo or schedule written by another user of the electronic device corresponding to the contact in the status information field 501. For example, information output in the status information field 501 may be user information received from an external device (e.g., electronic device of a person corresponding to the contact) through RCS features. The server for communication subscribers (e.g., server 106 in FIG. 1) may receive user information from an electronic device of a communication subscriber through RCS services. Then, the server may send the user information to another electronic device corresponding to a contact on the contacts list of the communication subscriber. Thereby, the processor 120 of the electronic device 500 may receive user information from the server 106 through RCS features and output the received user information in the status information field 501 of the corresponding contact.

In addition to output of the user information, the processor 120 of the electronic device 500 may output communication connectivity of the electronic device corresponding to the contact in the state indication field 502. For example, when the electronic device 500 is communicable with the electronic device corresponding to the contact, the processor 120 may output a green round image in the state indication field 502. When the electronic device 500 has difficulty in communicating with the electronic device corresponding to the contact, the processor 120 may output a yellow round image in the state indication field as indicated by indicia 503. When the electronic device 500 is unable to communicate with the electronic device corresponding to the contact, the processor 120 may output a grey round image in the state indication field as indicated by indicia 504. Difficulty of communication may be determined by user settings (e.g., “away” in a messenger) in the electronic device corresponding to the contact. Inability of communication may be determined by turning off the electronic device corresponding to the contact or user settings (e.g., “offline” in a messenger) therein. In addition to the contacts list, the processor 120 of the electronic device 500 may output user information along with the log of recent calls. The processor 120 of the electronic device 500 may also output indicators for “video calling is possible”, “only messaging is possible” in the state indication field 502.

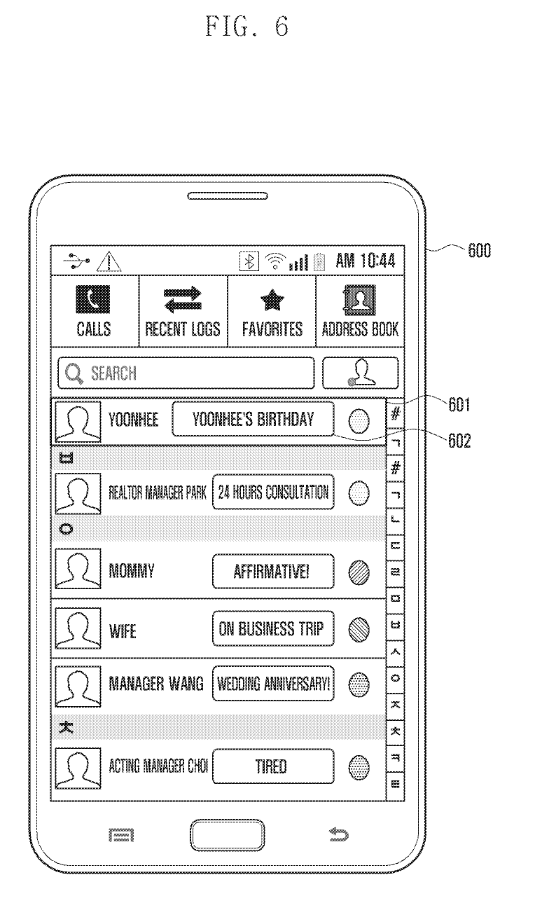

FIG. 6 is a screen representation for moving a contact whose intimacy level is above a threshold value to the topmost position on the contacts list according to an embodiment of the present disclosure.

Referring to FIG. 6, the processor 120 of the electronic device 600 may move a contact whose intimacy level is above a threshold value to the topmost position on the contacts list (e.g., address book) as indicated by indicia 601. For example, the processor 120 may move the contact 601 whose intimacy level is above the threshold value to the topmost position on the contacts list or display the contact 601 at the topmost position on the contacts list. Movement of a specific contact to the topmost position or display of the same at the topmost position may be an example for reorganization of the contacts list. When the user browses the contacts list, the user may readily identify the user information related to the contact at the topmost position of the contacts list. When a contact has an intimacy level below the threshold value, the processor 120 may output the received user information in the state indication field 602 of the contact only without reorganization of the contacts list. In other words, when the contact 601 has an intimacy level below the threshold value, the contents of the state indication field 602 of the contact 601 may only be updated with the received user information without reorganization of the contacts list.

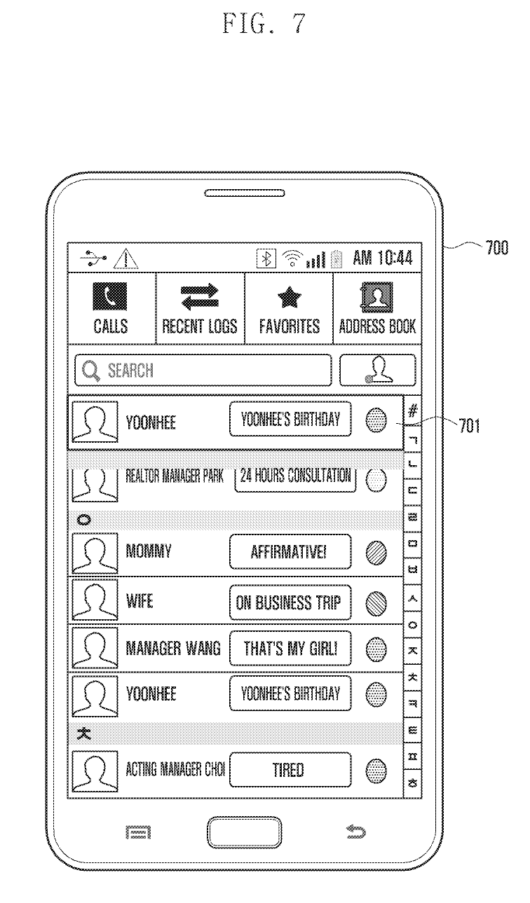

FIG. 7 is a screen representation for outputting a contact whose intimacy level is above a threshold value as an image fixed on the contacts list according to various embodiments of the present disclosure.

Referring to FIG. 7, the processor 120 of the electronic device 700 may output a contact whose intimacy level is above a threshold value as an image fixed on the contacts list as indicated by indicia 701. The contact 701 may be viewed constantly on the contacts list while the contacts list is being browsed. When the contact 701 is output as a fixed image, the contact 701 may be displayed constantly on the screen although the contacts list is scrolled. In the event that a contact of the contacts list is output as a fixed image, when the user sends a message to the contact or makes a call to the contact, the contacts list may be returned to the original form. When the user cancels output of a contact as a fixed image, the contacts list may also be returned to the original form.

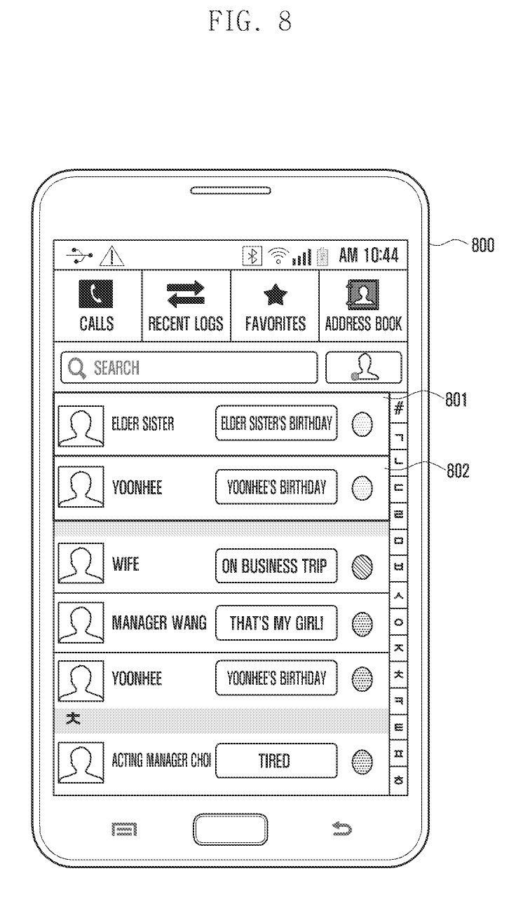

FIG. 8 is a screen representation for determining display order of multiple contacts whose intimacy levels are above a threshold value according to an embodiment of the present disclosure.

Referring to FIG. 8, when multiple contacts have an intimacy level above a threshold value, the processor 120 of the electronic device 800 may output the contacts in order of priority based on the intimacy level. The level of intimacy may be computed on the basis of the number of calls, the number of messages, the number of missed calls, the number of silent messages, the sizes of messages, call duration times, relationship with the user, or a combination thereof. The processor 120 may compute priority values of contacts based on their intimacy levels. The processor 120 may place a contact 801 with the highest priority at the topmost position of the contacts list and place a contact 802 with the second highest priority immediately below the contact 801. The processor 120 may determine the number of contacts that can be output as a fixed image according to user settings. For example, when the user sets the number of contacts that can be output as a fixed image to 2, the processor 120 may output up to two contacts as a fixed image. In this case, when three contacts have a scheduled event on the same date, the processor 120 may output up to two of the three contacts as a fixed image according to the priority. Thereafter, when one of the two contacts is erased, the processor 120 may output the remaining contact. When the user sends a message to the contact output as a fixed image or makes a call thereto, the processor 120 may cancel output of the contact output as a fixed image on the contacts list.

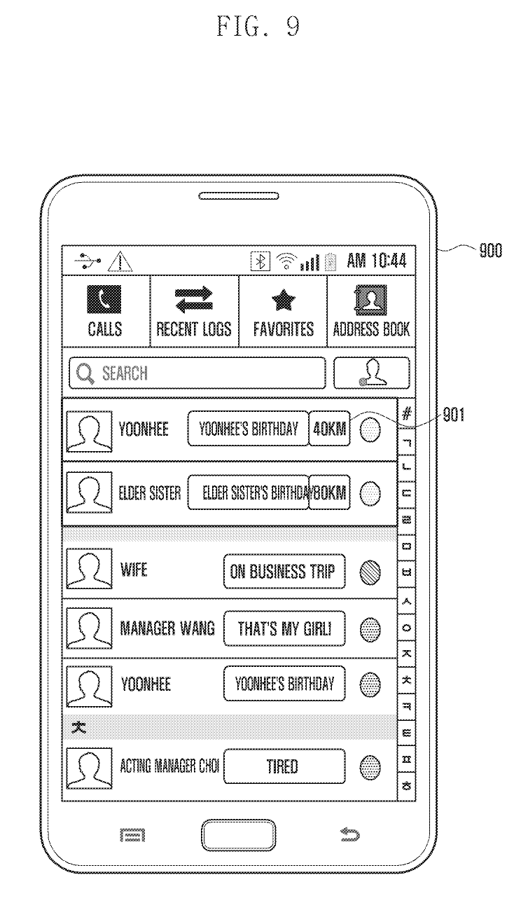

FIG. 9 is a screen representation in which, when multiple contacts have an intimacy level higher than a threshold value, distances to electronic devices related respectively with the multiple contacts are estimated and displayed on a contacts list, and a display order of the multiple contacts is determined in accordance with the estimated distances according to an embodiment of the present disclosure.

Referring to FIG. 9, when multiple contacts have an intimacy level higher than a threshold value, the processor 120 of the electronic device 900 may estimate distances between the electronic device 900 and electronic devices corresponding respectively to the contacts, display the estimated distance as indicated by indicia 901, and output the contacts in order (or reverse) order of distance. The distance between the electronic device 900 and the electronic device corresponding to a contact may be measured using signals from GPS satellites. The electronic device 900 may determine the display order of contacts on a contacts list on the basis of the level of intimacy or the distance between the electronic device 900 and the electronic device corresponding to a contact.

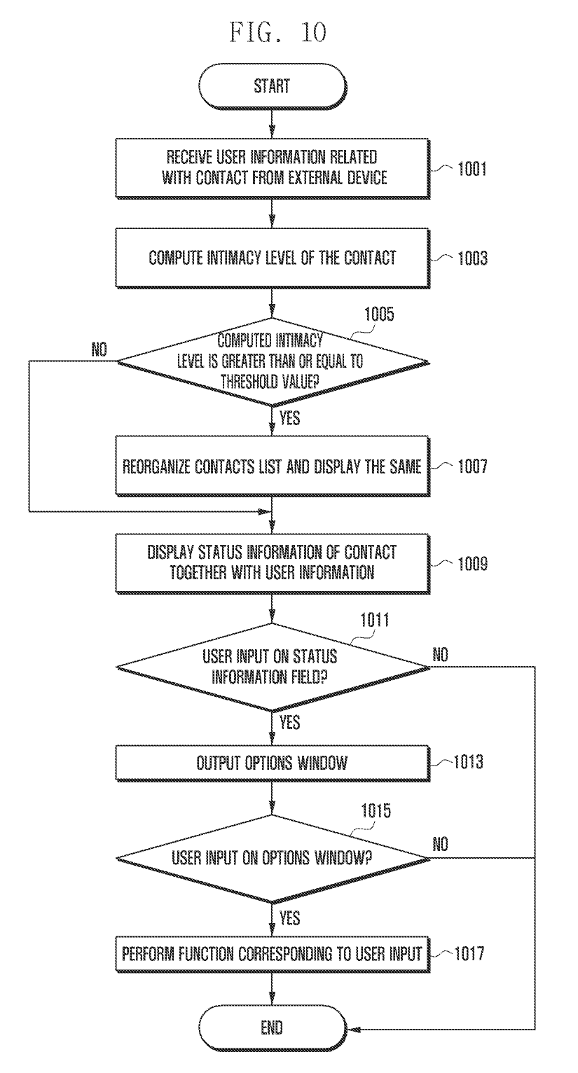

FIG. 10 is a flowchart of a method for displaying an options window in the reorganized contacts list and performing a function selected through the options window according to an embodiment of the present disclosure.

Referring to FIG. 10, operations 1001 to 1009 are identical respectively to operations 401 to 409 of FIG. 4 and a description thereof is omitted. At operation 1009, the processor 120 of the electronic device 101 displays the user information in the status information field of the corresponding contact. At operation 1011, the processor 120 determines whether user input through the input unit (e.g., input unit 250 of FIG. 2) is detected on the status information field. If user input is not detected on the status information field, the processor 120 ends the procedure. If no user input is detected, the processor 120 of the electronic device 101 may stop further processing.

If user input is detected on the status information field, the processor 120 may output an options window at operation 1013. The options window may be a selection window for functions including “make a call”, “send a message” and “offer a gift”. For example, in the event that the user information output in the status information field indicates the birthday of a person corresponding to the contact, the user may enter an input on the status information field to cause the options window to be output, and may select one of the functions listed in the options window. The functions provided in the options window may be configured by the user. At operation 1015, the processor 120 determines whether user input through the input unit 250 is detected on the options window. If no user input is detected on the options window, the processor 120 may end the procedure. If user input is detected on the options window, then at operation 1017, the processor 120 performs a function corresponding to the user input. Although not shown, after performing the function corresponding to the user input, the processor 120 may restore the original contacts list prior to reorganization. In addition to restoration of the original contacts list, the processor 120 may also replace the user information displayed in the status information field with the existing memo stored in the memory 130.

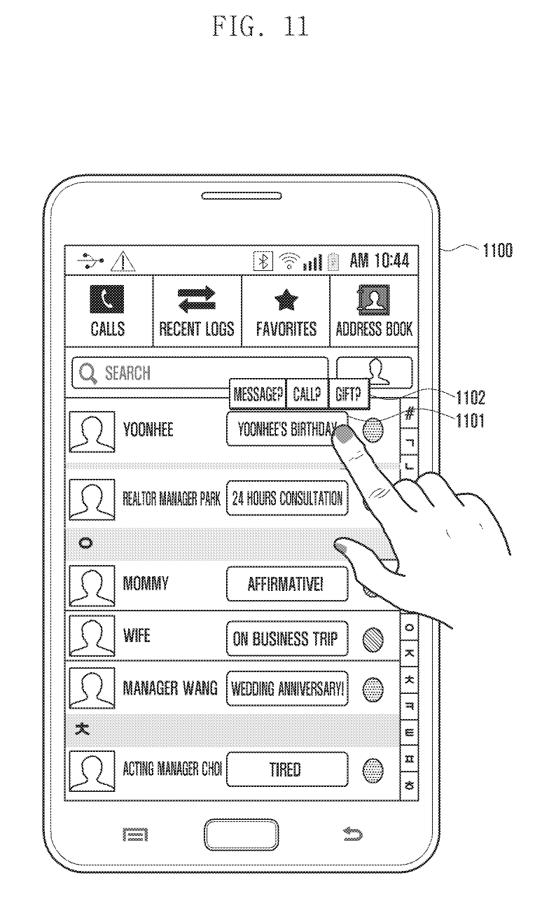

FIG. 11 is a screen representation for displaying an options window including available functions in response to user selection on a status information field according to various embodiments of the present disclosure.

Referring to FIG. 11, when user input through the input unit 250 is detected on the status information field 1101, the processor 120 of the electronic device 101 may output an options window 1102. The processor 120 may connect to a preset site to make a call to the corresponding contact, send a message thereto, or offer a gift thereto according to selection through the options window 1102. In response to user input detected on the options window 1102, the processor 120 may directly send a message to the corresponding contact or make a call thereto. The functions provided in the options window 1102 may be configured by the user. The processor 120 may output the options window 1102 when the user clicks not only the contact corresponding to user information received from the server but also a different contact. After sending a message or making a call through the options window 1102, the processor 120 may restore the original contacts list prior to reorganization. The processor 120 may also restore the original contents in the status information field 1101 before reception of the user information.

According to various embodiments of the present disclosure, the method for displaying contacts in an electronic device includes receiving user information corresponding to a contact from an external device; computing the intimacy level of the contact; and displaying the contact together with the user information on the basis of the intimacy level.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for displaying contacts in an electronic device, the method comprising:
receiving user information corresponding to a contact from an external device;
computing an intimacy level of the corresponding contact; and
displaying the contact together with the user information based on the intimacy level.

2. The method of claim 1, wherein the user information corresponds to at least one of schedule information, address information, network status information, network connectivity information, status information, and location information.

3. The method of claim 1, wherein the computing of the intimacy level comprises:
determining the level of intimacy based on at least one of a number of calls, a number of messages, a number of missed calls, a number of silent messages, sizes of messages, call duration times, a number of instant messages, a number of Social Networking Site (SNS) interactions, and a relationship with a user of the electronic device.

4. The method of claim 1, wherein the displaying of the contact comprises:
reorganizing, when the intimacy level of the contact is greater than or equal to a preset threshold value, a contacts list containing the contact; and
displaying the reorganized contacts list.

5. The method of claim 4, wherein the reorganizing of the contacts list and the displaying of the reorganized contacts list comprises:
moving the contact to the topmost position on the contacts list.

6. The method of claim 4, wherein the reorganizing of the contacts list and the displaying of the reorganized contacts list comprises:
outputting the contact as an image fixed on the contacts list.

7. The method of claim 4, wherein the threshold value is set in advance by the external device or according to user settings and is a numerical value representing a level of intimacy.

8. The method of claim 1, wherein the displaying of the contact comprises:
displaying at least one piece of information among the user information corresponding to the contact.

9. The method of claim 4, wherein the reorganizing of the contacts list and the displaying of the reorganized contacts list comprises:
reorganizing, when two or more contacts have registered user information for the same date, the contacts list according to at least one of intimacy levels of the contacts and distances to electronic devices corresponding respectively to the contacts; and
displaying the reorganized contacts list.

10. The method of claim 1, further comprising:
outputting, when user input is detected on the contact, an options window; and
performing a specific function corresponding to user input detected on the options window.

11. The method of claim 10, wherein the performing of the specific function comprises at least one of:
making a call;
sending a message; and
offering a gift.

12. A method for sending user information from an external device to an electronic device, the method comprising:
receiving user information from a first electronic device related with a contact of a contacts list; and
sending the user information to a second electronic device listed in the contacts list in a timely manner according to a scheduled date indicated by the received user information.

13. The method of claim 12, wherein the sending of the user information to the second electronic device in a timely manner comprises:
storing the user information in the external device; and
sending the user information to the second electronic device when the external device is able to communicate with the second electronic device.

14. An electronic device comprising:
a wireless communication unit configured to receive user information related with a contact from an external device;
a display; and
a processor configured to perform a process of:
receiving user information corresponding to a contact from the external device, computing an intimacy level of the corresponding contact, and
displaying the contact together with the user information based on the intimacy level.

15. The electronic device of claim 14, wherein the processor computes the level of intimacy based on at least one of a number of calls, a number of messages, a number of missed calls, a number of silent messages, sizes of messages, call duration times, a number of instant messages, a number of Social Networking Site (SNS) interactions, and a relationship with a user of the electronic device.

16. The electronic device of claim 14, wherein, when the intimacy level of the contact is greater than or equal to a preset threshold value, the processor reorganizes a contacts list containing the contact and displays the reorganized contacts list.

17. The electronic device of claim 16, wherein, to reorganize the contacts list, the processor moves the contact to the topmost position on the contacts list or outputs the contact as an image fixed on the contacts list.

18. The electronic device of claim 14, wherein the processor displays at least one piece of information among the user information corresponding to the contact.

19. The electronic device of claim 14, wherein, when two or more contacts have registered user information for the same date, the processor reorganizes the contacts list according to at least one of intimacy levels of the contacts and distances to electronic devices corresponding respectively to the contacts, and displays the reorganized contacts list.

20. The electronic device of claim 14, further comprising:
an input/output interface configured to detect user input,
wherein the processor outputs an options window when user input is detected on the contact, and makes a call, sends a message, or offers a gift corresponding to user input detected on the options window.
